(19) United States
(12) Patent Application Publication
(10) Pub. No.: US 2013/0083772 A1
(43) Pub. Date: Apr. 4, 2013

(54) WIRELESS COMMUNICATION TERMINAL AND WIRELESS COMMUNICATION METHOD

(71) Applicant: Yoshiaki HATA, Nishitokyo (JP)

(72) Inventor: Yoshiaki HATA, Nishitokyo (JP)

(73) Assignee: FUJITSU MOBILE COMMUNICATIONS LIMITED, Kawasaki-shi (JP)

(21) Appl. No.: 13/584,425

(22) Filed: Aug. 13, 2012

(30) Foreign Application Priority Data
Sep. 30, 2011 (JP) 2011-218012

(51) Int. Cl. H04W 84/12

(52) U.S. Cl. 370/331

(57) ABSTRACT

A wireless communication terminal includes a wireless communication circuit that wireless connects to a first or a second network; a processor that controls switching of a network to which the wireless communication circuit connects; and a timer that starts counting based on a wireless communication state and finishes counting a first time period when a given time period has elapsed, and counts a second time period that is longer than the first time period. The processor maintains the first network to which the wireless communication circuit connects and attempts re-connection to the first network until the timer finishes counting the first time period, switches a destination of the wireless communication circuit to the second network if there is a connectable second network when the timer finishes counting the first time period, and if not, attempts re-connection to the first network until the timer finishes counting the second time period.

### CROSS REFERENCE TO RELATED APPLICATIONS

This application is based upon and claims the benefit of priority of the prior Japanese Patent Application No. 2011-218012, filed on Sep. 30, 2011, the entire contents of which are incorporated herein by reference.

### FIELD

The embodiments discussed herein are related to a wireless communication terminal and a wireless communication method.

### BACKGROUND

A mobile communications system employing a wireless local area network (WLAN) terminal and a personal handyphone system (PHS) terminal that are connectable to a multi-line telephone apparatus has been conventionally used. If the WLAN terminal of such a mobile communications system starts handover during communication with a telephone connected to the multi-line telephone apparatus, the multi-line telephone apparatus performs handover by switching the destination of the communication from the WLAN terminal to the PHS terminal (see, for example, Japanese Laid-Open Patent Publication No. 2009-232142).

On the other hand, a wireless communication terminal compatible with multiple communication schemes has been also used. If such a radio communication terminal is requested to start communication when the terminal is out of the coverage area, the terminal performs channel detection for a time period that is set according to the time that has elapsed since the terminal is determined to be out of the coverage area until the terminal starts the channel detection (see, for example, Japanese Laid-Open Patent Publication No. 2008-113249).

A wireless communication terminal compatible with code division multiple access (CDMA) and world interoperability for microwave access (WiMAX) (registered trademark) has been also used. If the wireless communication terminal becomes unable to maintain connection with a higher station (e.g., a base station) by the currently-used communication scheme, the wireless communication terminal attempts to re-establish connection according to the same communication scheme for a given period of time, and then attempts to establish connection according to another communication scheme.

In the conventional wireless communication terminals, however, the later the switching of the communication scheme is, the longer the time becomes during which the terminal attempts to re-establish connection according to the same communication scheme, when connection to the currently-used network is cut. Further, the later the determination that the terminal, which cannot establish connection by any of the communication schemes, is out of the coverage area is, the longer the time becomes during which connection is cut. Thus, the time during which a higher-layer application cannot transmit/receive data becomes long.

On the other hand, if the switching of the communication schemes is too early, the destination is switched to another network soon after the communication state of the currently-used network deteriorates. If the communication state of the previously-used network is improved immediately after the switching, the destination is switched to the previously-used network again, thereby causing the terminal to shuttle between two communication schemes frequently. Accordingly, the communication environment becomes unstable, resulting in quick battery consumption and a longer time during which data cannot be transmitted/received due to increased processing for the switching of the destination network.

### SUMMARY

According to an aspect of an embodiment, a wireless communication terminal includes a wireless communication circuit that connects to any one of a first network by wireless communication according to a communication protocol corresponding to the first network and a second network by wireless communication according to a communication protocol corresponding to the second network; a processor that controls switching of a network to which the wireless communication circuit connects; and a timer that starts to count based on a state of wireless communication and finishes counting a first time period after a given time period has elapsed, and starts to count based on the state of wireless communication and finishes counting a second time period that is longer than the first time period. The processor maintains the first network to which the wireless communication circuit connects and attempts to re-connect to the first network until the timer finishes counting the first time period, switches a destination of the wireless communication circuit to the second network if there is a connectable second network when the timer finishes counting the first time period, and

attempts, until the timer finishes counting the second time period, to re-connect to the first network that has been maintained as the destination until the timer finishes counting the first time period, if there is no connectable second network when the timer finishes counting the first time period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a wireless communication terminal according to a first embodiment;

FIG. 2 is a flowchart of a wireless communication method according to the first embodiment;

FIG. 3 is a block diagram of a wireless communications system according to a second embodiment;

FIG. 4 is a schematic of an example of service areas of the wireless communications system according to the second embodiment;

FIG. 5 is a hardware block diagram of a wireless communication terminal according to the second embodiment;

FIG. 6 is a functional diagram of the wireless communication terminal according to the second embodiment;

FIG. 7 is a schematic of the relationship between a timer and the operation of the wireless communication terminal according to the second embodiment;

FIG. 8 is a schematic of the relationship between the timer and the operation of the wireless communication terminal according to the second embodiment;

FIG. 9A is a flowchart of a wireless communication method according to the second embodiment;

FIG. 9B is a continuation of the flowchart of FIG. 9A;

FIG. 10A is a flowchart of the wireless communication method according to the second embodiment;

FIG. 10B is a continuation of the flowchart of FIG. 10A;

FIG. 11A is a flowchart of the wireless communication method according to the second embodiment; and

FIG. 11B is a continuation of the flowchart of FIG. 11A.

### DESCRIPTION OF EMBODIMENTS

Preferred embodiments of a wireless communication terminal and a wireless communication method are described in detail below with reference to the accompanying drawings. In the following description of the embodiments, similar components are assigned the same signs and description thereof is omitted.

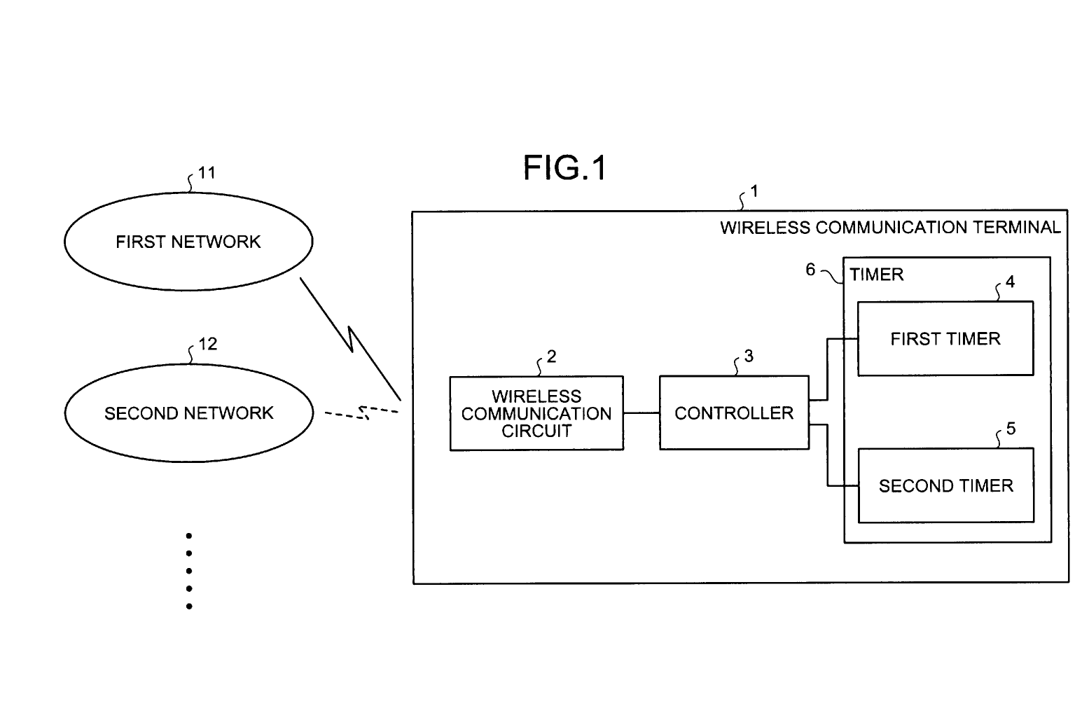

FIG. 1 is a block diagram of a wireless communication terminal according to a first embodiment. As depicted in FIG. 1, a wireless communication terminal 1 includes a wireless communication circuit 2, a controller 3, and a timer 6. The timer 6 may include only one timer, or multiple timers such as a first timer 4 and a second timer 5. If the timer 6 includes only one timer, the timer counts a first time period and a second time period described later. In the following embodiments, however, the timer 6 includes the first timer 4 and the second timer 5 that count the first time period and the second time period, respectively.

The wireless communication circuit 2 connects to a first network 11 or a second network 12 of different communication schemes by wireless communication according to the respective communication schemes. The controller 3 controls switching of the networks 11 and 12 to which the wireless communication circuit 2 connects. The first timer 4 starts to count based on a state of wireless communication, and finishes counting the first time period when a given time period has elapsed. The second timer 5 starts to count based on a state of wireless communication, and finishes counting the second time period that is longer than the first time period.

Until the first timer 4 finishes counting the first time period, the controller 3 maintains the first network 11 to which the wireless communication circuit 2 connects and attempts to re-connect to the first network 11. There may be or may not be a connectable second network 12 when the first timer 4 finishes counting the first time period.

If there is a connectable second network 12, the controller 3 switches the destination of the wireless communication circuit 2 to the second network 12. If there is no connectable second network 12, until the second timer 5 finishes counting the second time period, the controller 3 attempts to re-connect to the first network 11 that has been maintained as the destination until the first timer 4 finishes counting the first time period.

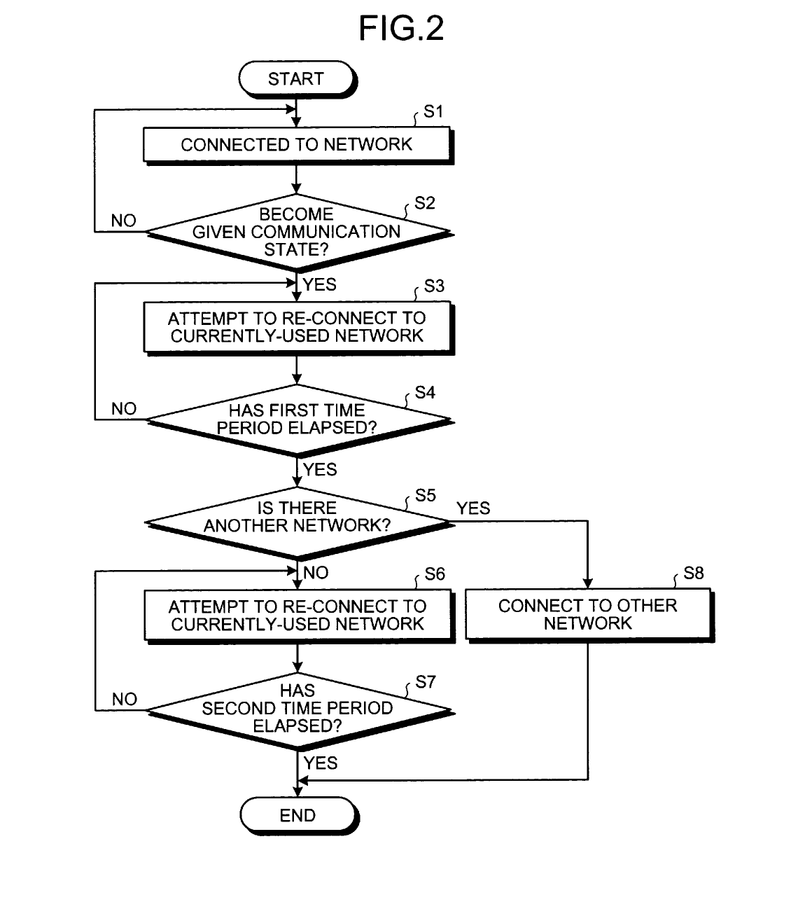

FIG. 2 is a flowchart of a wireless communication method according to the first embodiment. As depicted in FIG. 2, upon start of wireless connection to a higher station (e.g. a base station and an access point), the wireless communication circuit 2 of the wireless communication terminal 1 connects to the first network 11 among connectable networks according to the communication scheme corresponding to the first network 11 (step S1), and continues to connect to the first network 11 (step S1) until the state of wireless communication with the first network 11 becomes a given state (step S2: NO).

If the state of wireless communication with the first network 11 becomes the given state where, for example, the communication/connection state of the currently-used first network 11 deteriorates preventing communication or destabilizing the connection (step S2: YES), the controller 3 of the wireless communication terminal 1 maintains the first network 11 as the destination until the first time period counted by the first timer 4 elapses (step S4: NO), and attempts to re-connect to the currently-used network (i.e., the first network 11) according to the communication scheme corresponding to the first network 11 by the wireless communication circuit 2 (step S3).

On the other hand, when the first time period has elapsed (step S4: YES) and if there is a second network 12 that is connectable according to another communication scheme (step S5: YES), the controller 3 switches the destination of the wireless communication circuit 2 to the second network 12. That is, the controller 3 connects to the second network 12 according to the communication scheme corresponding to the second network 12 by the wireless communication circuit 2 (step S8), thereby ending the sequence of processes. If the state of wireless communication with the second network 12 becomes the given state where, for example, the communication/connection environment of the currently-used second network 12 deteriorates preventing communication or destabilizing the connection, step S3 and subsequent processes are executed.

On the other hand, if there is no second network 12 that is connectable according to another communication scheme (step S5: NO), the controller 3 attempts to re-connect to the currently-used network (i.e., the first network 11) according to the communication scheme corresponding to the first network 11 by the wireless communication circuit 2 (step S6) until the second time period counted by the second timer 5 elapses (step S7: NO).

When the second time period has elapsed (step S7: YES), the controller 3 sets the state of wireless communication to be out of the coverage area, thereby ending the sequence of processes. If the wireless communication terminal 1 returns from outside a coverage area to the coverage area of a connectable network, step S1 and subsequent processes are executed.

According to the first embodiment, if the communication state with the currently-used destination network deteriorates, the wireless communication terminal 1 switches the destination to another connectable network when the first time period has elapsed. Thus, the time during which an application cannot transmit/receive data can be shorter compared to attempting to re-connect to the previously-used network until the second time period elapses.

Further, according to the first embodiment, the wireless communication terminal 1 attempts to re-connect to the currently-used destination network until the first time period has elapsed even when the communication state with the currently-used destination network deteriorates. Thus, frequent shuttling between multiple communication schemes when the communication state is unstable for all of the communication schemes can be avoided, thereby stabilizing the communication environment.

Further, according to the first embodiment, the wireless communication terminal 1 attempts to re-connect to the currently-used destination network until the second time period elapses if there is no other connectable network when the first time period has elapsed. Thus, the wireless communication terminal 1 connects to the currently-used destination network again if the communication state with the currently-used destination network is improved after the elapse of the first time period and before the elapse of the second time period, thereby enabling a wireless communication terminal having high connectability to be provided.

Although not particularly limited hereto, the wireless communication terminal according to a second embodiment is a multi-mode terminal compatible with three communication schemes, for example, wireless fidelity (Wi-Fi) (registered trademark), WiMAX, and CDMA. CDMA may include CDMA 1x/evolution data only (EVDO). The multi-mode terminal may be compatible with two, or four or more communication schemes.

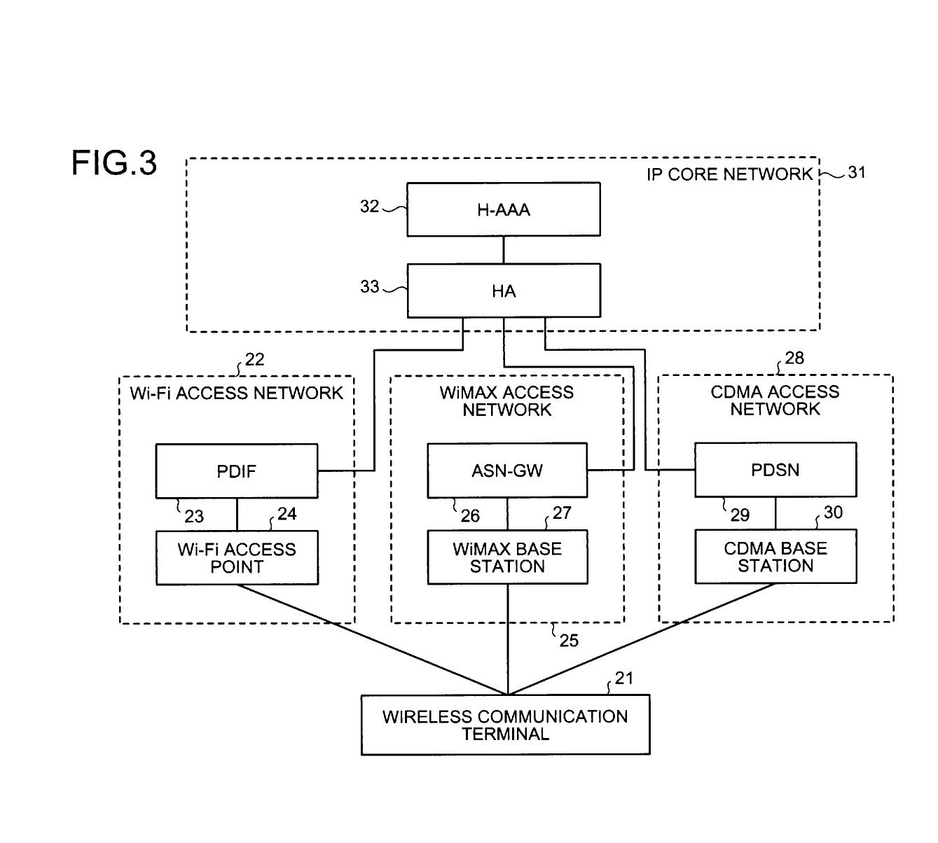

FIG. 3 is a block diagram of a wireless communications system according to the second embodiment. As depicted in FIG. 3, the wireless communications system includes a wireless communication terminal 21, a Wi-Fi access network 22, a WiMAX access network 25, a CDMA access network 28, and an IP core network 31.

The Wi-Fi access network 22 includes a packet data interface (PDIF) 23 and a Wi-Fi access point 24. The wireless communication terminal 21 connects to the Wi-Fi access point 24 according to the Wi-Fi communication scheme. The PDIF 23 is connected to the Wi-Fi access point 24 and the home agent (HA) 33 of the IP core network 31, and transmits/receives data between the Wi-Fi access point 24 and the HA 33.

The WiMAX access network 25 includes an access service network gateway (ASN-GW) 26 and a WiMAX base station 27. The wireless communication terminal 21 connects to the WiMAX base station 27 according to the WiMAX communication scheme. The ASN-GW 26 is connected to the WiMAX base station 27 and the HA 33, and transmits/receives data between the WiMAX base station 27 and the HA 33.

The CDMA access network 28 includes a packet data serving node (PDSN) 29 and a CDMA base station 30. The wireless communication terminal 21 connects to the CDMA base station 30 according to the CDMA communication scheme. The PDSN 29 is connected to the CDMA base station 30 and the HA 33, and transmits/receives data between the CDMA base station 30 and the HA 33. The Wi-Fi access point 24, the WiMAX base station 27, and the CDMA base station 30 are higher stations (parent stations) on the network side with respect to the wireless communication terminal 21.

The IP core network 31 includes a home authentication, authorization and accounting (HAAA) 32 and HA 33. The HA 33 manages position data of the wireless communication terminal 21, and transmits/receives data (e.g., IP packet) between the HAAA 32 and each of the Wi-Fi access network 22, the WiMAX access network 25, and the CDMA access network 28. The HAAA 32 is a server for authentication, authorization and accounting.

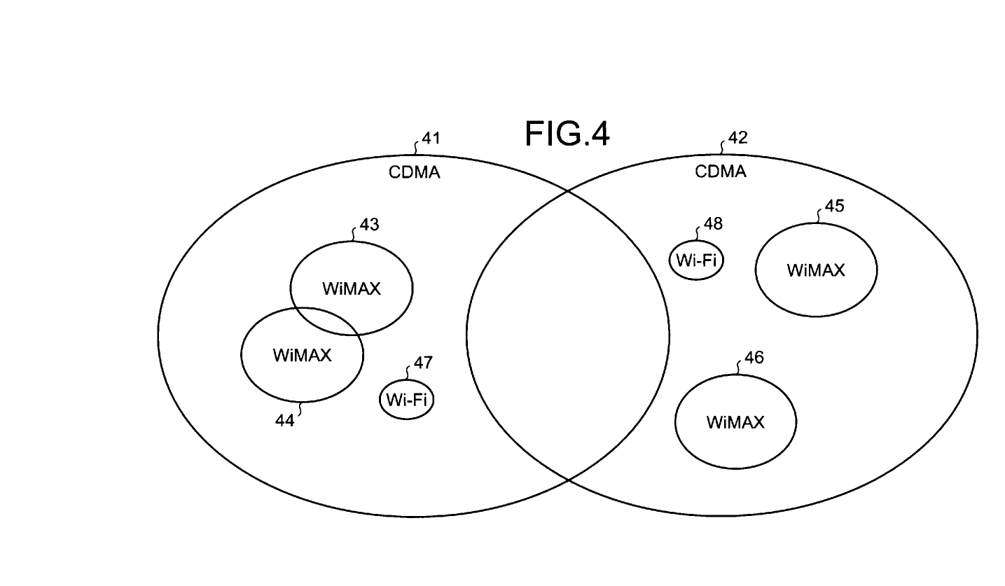

FIG. 4 is a schematic of an example of service areas of the wireless communications system according to the second embodiment. As depicted in FIG. 4, coverage areas 41 and 42 of base stations of CDMA are broad, and thus areas that are out of the coverage areas are small. Coverage areas 43, 44, 45, and 46 of base stations of WiMAX are a medium size and smaller than the coverage areas 41 and 42 of CDMA, and thus there can be areas in between that are out of the coverage areas 43, 44, 45, and 46. Coverage areas 47 and 48 of access points of Wi-Fi are still smaller and can be local.

Priority of the networks for the wireless communication terminal 21 to connect can be determined according to various situations such as the size/arrangement of the service areas of higher stations on the network side, the arrangement of areas that are out of the coverage areas, and communication speed. For example, Wi-Fi, WiMAX, and CDMA may have the first, the second, and the third priority as described in the following.

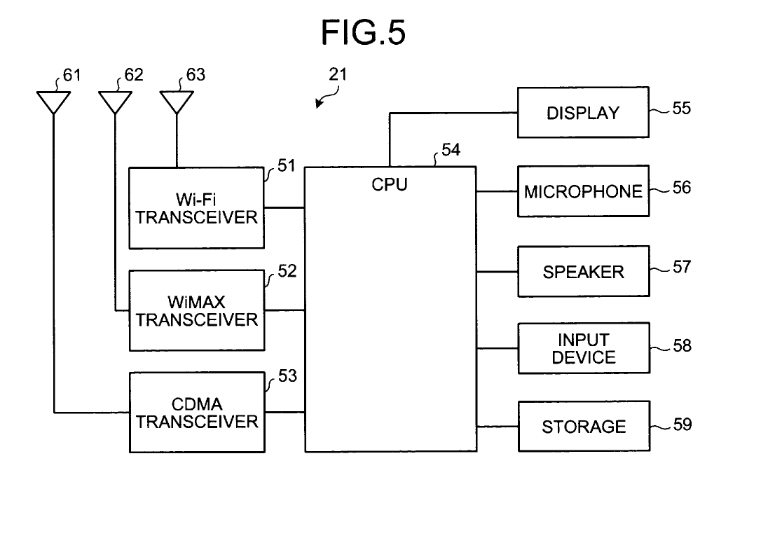

FIG. 5 is a hardware block diagram of a wireless communication terminal according to the second embodiment. As depicted in FIG. 5, the wireless communication terminal 21 includes a Wi-Fi transceiver 51, a WiMAX transceiver 52, and a CDMA transceiver 53 corresponding to Wi-Fi, WiMAX, and CDMA, respectively, as wireless communication circuits. An antenna 63 for Wi-Fi, an antenna 62 for WiMAX, and an antenna 61 for CDMA are connected to the Wi-Fi transceiver 51, the WiMAX transceiver 52, and the CDMA transceiver 53, respectively.

The wireless communication terminal 21 includes modules such as a central processing unit (CPU) 54, a display 55 (e.g., a liquid-crystal display), a microphone 56, a speaker 57, and an input device 58 (e.g., a key pad). The wireless communication terminal 21 also includes modules of storage 59 such as a random access memory (RAM), a read only memory (ROM), and a flash memory.

The storage 59 may store a program and an application program implementing the wireless communication method described later. The program and the application program are read out from the storage 59 and executed by the CPU 54. The modules 55 to 59, as well as the Wi-Fi transceiver 51, the WiMAX transceiver 52, and the CDMA transceiver 53, are controlled by the CPU 54.

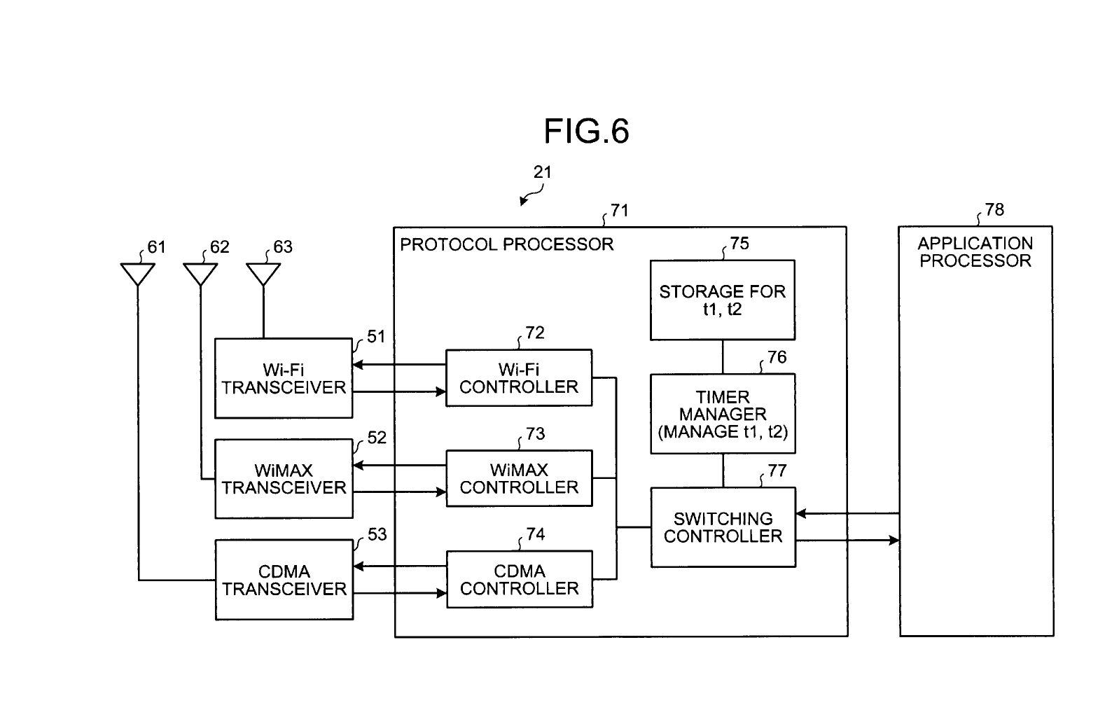

FIG. 6 is a functional block diagram of the wireless communication terminal according to the second embodiment. As depicted in FIG. 6, the wireless communication terminal 21 includes a protocol processor 71 and an application processor 78. The protocol processor 71 controls communication and exchanges data between the application processor 78 and each of the Wi-Fi transceiver 51, the WiMAX transceiver 52, and the CDMA transceiver 53. The protocol processor 71 is implemented by the CPU 54 executing the program implementing the wireless communication method described later.

The application processor 78 executes an application, and may be implemented by the CPU 54 executing the application program.

The protocol processor 71 includes a Wi-Fi controller 72, a WiMAX controller 73, and a CDMA controller 74. The Wi-Fi controller 72 controls the Wi-Fi transceiver 51 and exchanges data with the Wi-Fi transceiver 51. The WiMAX controller 73 controls the WiMAX transceiver 52 and exchanges data with the WiMAX transceiver 52. The CDMA controller 74 controls the CDMA transceiver 53 and exchanges data with the CDMA transceiver 53.

The protocol processor 71 includes storage 75, a timer manager 76, and a switching controller 77 as a controller. The switching controller 77 controls the switching of communication schemes for the Wi-Fi controller 72, the WiMAX controller 73, and the CDMA controller 74, and exchanges data with the application processor 78.

The storage 75 may include a t1 timer (i.e., the first timer) for counting a t1 time period (i.e., the first time period) and a t2 timer (i.e., the second timer) for counting a t2 time period (i.e., the second time period) (t1<t2) that are implemented by software. Since the t2 time period is longer than the t1 time period, the t2 timer finishes counting after the t1 timer if the t1 timer and the t2 timer start to count at the same time. The wireless communication terminal 21 may continue re-connection according to the same communication scheme during the t1 time period for each of Wi-Fi, WiMAX, and CDMA. The wireless communication terminal 21 may retain identification information (e.g., IP address) assigned by the network for the t2 time period. The timer manager 76 manages the t1 timer and the t2 timer.

The t1 time period and the t2 time period may be determined for each communication scheme. For example, in a system having high area coverage where higher stations (e.g., base stations and access points) are densely arranged, the t1 time period may be short to promote the switching to another system. Among the three communication schemes described above, CDMA corresponds to the system having high area coverage. For CDMA, the t1 time period and the t2 time period may be 3 seconds and 30 seconds, respectively.

On the other hand, in a system having a low area coverage where higher stations are sparsely arranged, the t1 time period may be long such that the wireless communication terminal 21 attempts to re-connect to the same system and is not likely to switch to another system. Among three communication schemes described above, WiMAX corresponds to the system having low area coverage. For WiMAX, the t1 time period and the t2 time period may be 5 seconds and 50 seconds, respectively.

In a system where communication is performed basically under one higher station without hand-off between higher stations, both the t1 time period and the t2 time period may be long. Among the three communication schemes described above, Wi-Fi corresponds to the system without hand-off. For Wi-Fi, the t1 time period and the t2 time period may be 10 seconds and 120 seconds, respectively.

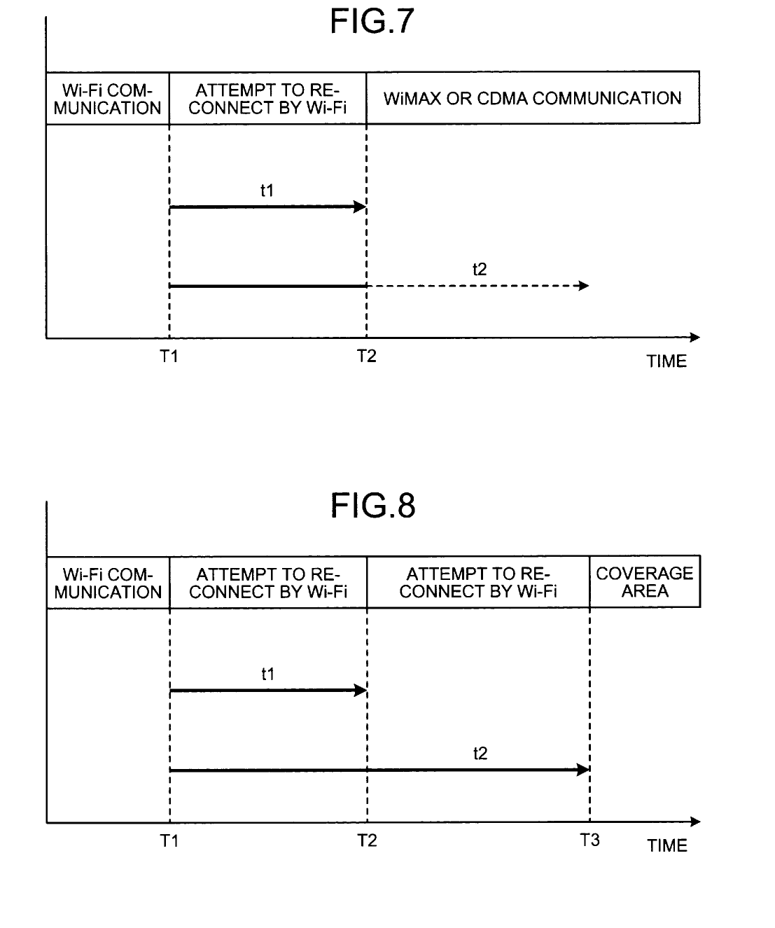

FIG. 7 is a schematic of the relationship between the timer and the operation of the wireless communication terminal according to the second embodiment. As depicted in FIG. 7, the t1 timer and the t2 timer may be started simultaneously at the time T1 when the state of wireless communication during stand-by mode in the currently-connected network deteriorates. In the example depicted in FIG. 7, the wireless communication terminal 21 is currently connected to the Wi-Fi access network 22 (i.e., the first network). The state of wireless communication is determined to have deteriorated when, for example, the Wi-Fi signal is dropped and/or a packet is lost during connection to the Wi-Fi access network 22.

During the counting by the t1 timer, the wireless communication terminal 21 continues to retry rescanning so as to revert to the stand-by mode in the currently-connected network (i.e., the Wi-Fi access network 22). At the same time, the wireless communication terminal 21 checks whether the other networks (i.e., the WiMAX access network 25 and the CDMA access network 28) are connectable.

The wireless communication terminal 21 stops the t1 timer and continues communication with the currently-connected network (i.e., the Wi-Fi access network 22) if the terminal 21 reverts to the stand-by mode in the network during the counting by the t1 timer. If the wireless communication terminal 21 cannot revert to the stand-by mode during the counting by the t1 timer, the wireless communication terminal 21 checks whether there is any other connectable network at the time T2 when the t1 timer finishes counting.

If there is any other connectable network, the wireless communication terminal 21 switches the destination from the currently-connected network (i.e., the Wi-Fi access network 22) to the other connectable network. In this case, the wireless communication terminal 21 may connect to the network according to the priority.

For example, the wireless communication terminal 21 switches the destination to the WiMAX access network 25 if the order of the communication schemes according to priority is Wi-Fi, WiMAX, and CDMA in descending order of priority, and the WiMAX access network 25 is connectable. In this case, the second network 12 is the WiMAX access network 25. The wireless communication terminal 21 switches the destination to the CDMA access network 28 if the WiMAX access network 25 is not connectable but the CDMA access network 28 is connectable. In this case, the second network 12 is the CDMA access network 28.

On the other hand, there may be no other connectable network at the time T2 at which the t1 timer finishes counting. In this case, the wireless communication terminal 21 continues to retry rescanning until the t2 timer finishes counting so as to revert to the stand-by mode in the currently-connected network (i.e., the Wi-Fi access network 22).

FIG. 8 is a schematic of the relationship between the timer and the operation of the wireless communication terminal according to the second embodiment. As depicted in FIG. 8, the wireless communication terminal 21 may not be able to revert to the stand-by mode in the currently-connected network (i.e., the Wi-Fi access network 22) during the counting by the t2 timer. In this case, the wireless communication terminal 21 releases the identification information (e.g., IP address) assigned by the network and at the time T3 when the t2 timer finishes counting, enters a state of being outside of the coverage area.

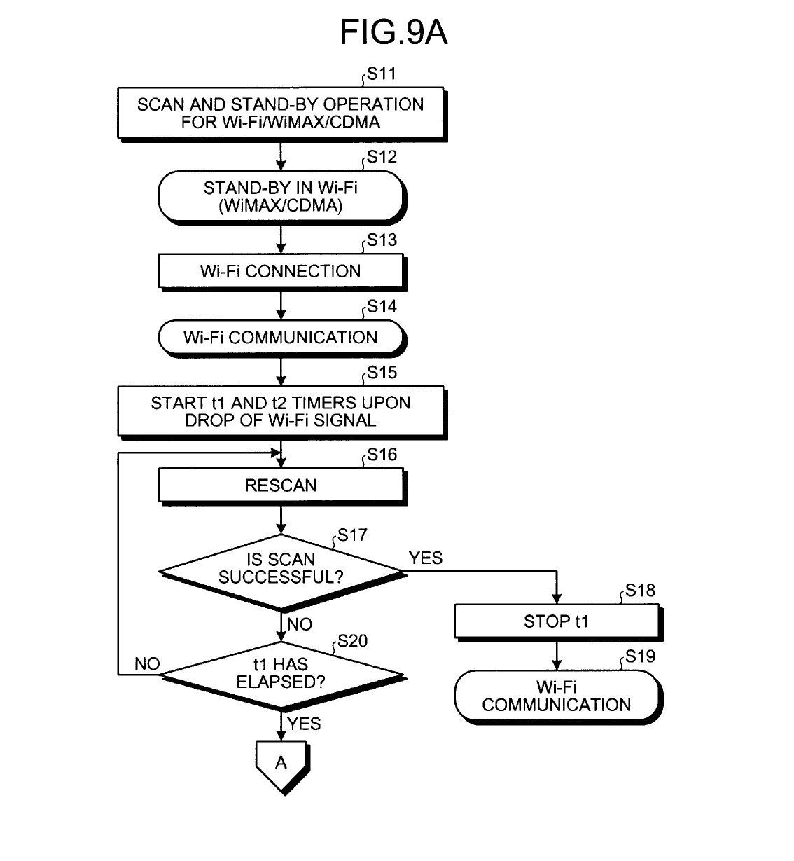

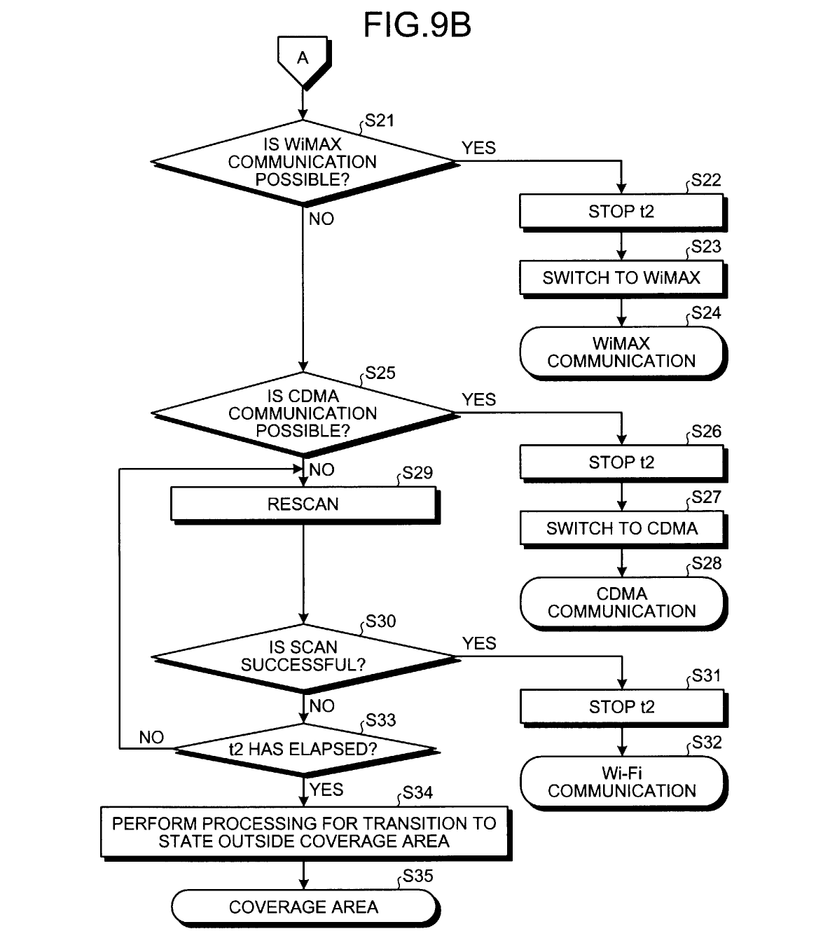

FIG. 9A is a flowchart of a wireless communication method according to the second embodiment, and FIG. 9B is the continuation thereof. As depicted in FIG. 9A, upon start of the wireless communication method, the Wi-Fi controller 72, the WiMAX controller 73, the CDMA controller 74, and the switching controller 77 of the wireless communication terminal 21 perform a scan and stand-by operation for Wi-Fi, WiMAX, and CDMA (step S11). As a result, the wireless communication terminal 21 enters stand-by mode in the Wi-Fi access network 22, for example (step S12).

If the result of the scan indicates that the Wi-Fi access network 22 is not connectable but the WiMAX access network 25 is connectable, the wireless communication terminal 21 enters stand-by mode in the WiMAX access network 25. If the result of the scan indicates that neither the Wi-Fi access network 22 nor the WiMAX access network 25 is connectable but the CDMA access network 28 is connectable, the wireless communication terminal 21 enters stand-by mode in the CDMA access network 28. Here, it is assumed that the wireless communication terminal 21 enters stand-by mode in the Wi-Fi access network 22. In this case, the first network is the Wi-Fi access network 22.

The Wi-Fi controller 72 and the switching controller 77 connect to the Wi-Fi access network 22 (step S13), thereby starting Wi-Fi communication (step S14). If the wireless communication terminal 21 drops a signal from the Wi-Fi access point 24 and becomes unsynchronized with the Wi-Fi access point 24 while in the stand-by mode during the Wi-Fi communication, the timer manager 76 starts the t1 timer and the t2 timer (step S15). During the counting by the t1 timer, the Wi-Fi controller 72, the WiMAX controller 73, the CDMA controller 74, and the switching controller 77 perform rescanning (step S16). The rescanning for WiMAX and CDMA can be omitted at step S16.

If rescanning is successful (step S17: YES) and the wireless communication terminal 21 can revert to the stand-by mode in the Wi-Fi access network 22, the timer manager 76 stops the t1 timer (step S18) and the wireless communication terminal 21 resumes Wi-Fi communication by the Wi-Fi controller 72 (step S19). If rescanning fails (step S17: NO), until the t1 timer finishes counting (step S20: NO), the Wi-Fi controller 72, the WiMAX controller 73, the CDMA controller 74, and the switching controller 77 repeat rescanning (step S16 to step S20).

When the t1 timer finishes counting (step S20: YES), as depicted in FIG. 9B, the switching controller 77 determines whether WiMAX communication is possible (step S21). If possible (step S21: YES), the timer manager 76 stops the t2 timer (step S22). The switching controller 77 switches the communication scheme to WiMAX (step S23), and the wireless communication terminal 21 starts WiMAX communication by the WiMAX controller 73 (step S24). In this case, the second network is the WiMAX access network 25.

On the other hand, if WiMAX communication is not possible (step S21: NO), the switching controller 77 determines whether CDMA communication is possible (step S25). If possible (step S25: YES), the timer manager 76 stops the t2 timer (step S26). The switching controller 77 switches the communication scheme to CDMA (step S27), and the wireless communication terminal 21 starts CDMA communication by the CDMA controller 74 (step S28). In this case, the second network is the CDMA access network 28.

On the other hand, if CDMA communication is not possible (step S25: NO), the Wi-Fi controller 72, the WiMAX controller 73, the CDMA controller 74, and the switching controller 77 perform rescanning (step S29). The rescanning for WiMAX and CDMA can be omitted at step S29.

If rescanning is successful (step S30: YES) and the wireless communication terminal 21 can revert to the stand-by mode in the Wi-Fi access network 22, the timer manager 76 stops the t2 timer (step S31) and the wireless communication terminal 21 resumes Wi-Fi communication by the Wi-Fi controller 72 (step S32). If rescanning fails (step S30: NO), until the t2 timer finishes counting (step S33: NO), the Wi-Fi controller 72, the WiMAX controller 73, the CDMA controller 74, and the switching controller 77 repeat rescanning (step S29 to step S33).

When the t2 timer finishes counting (step S33: YES), the switching controller 77 releases the identification information (e.g., IP address), and performs processing for transitioning to a state of being outside the coverage area (step S34). Thus, the wireless communication terminal 21 becomes outside the coverage area (step S35). The wireless communication terminal 21 that is out of the coverage area repeats step S11 and subsequent processes.

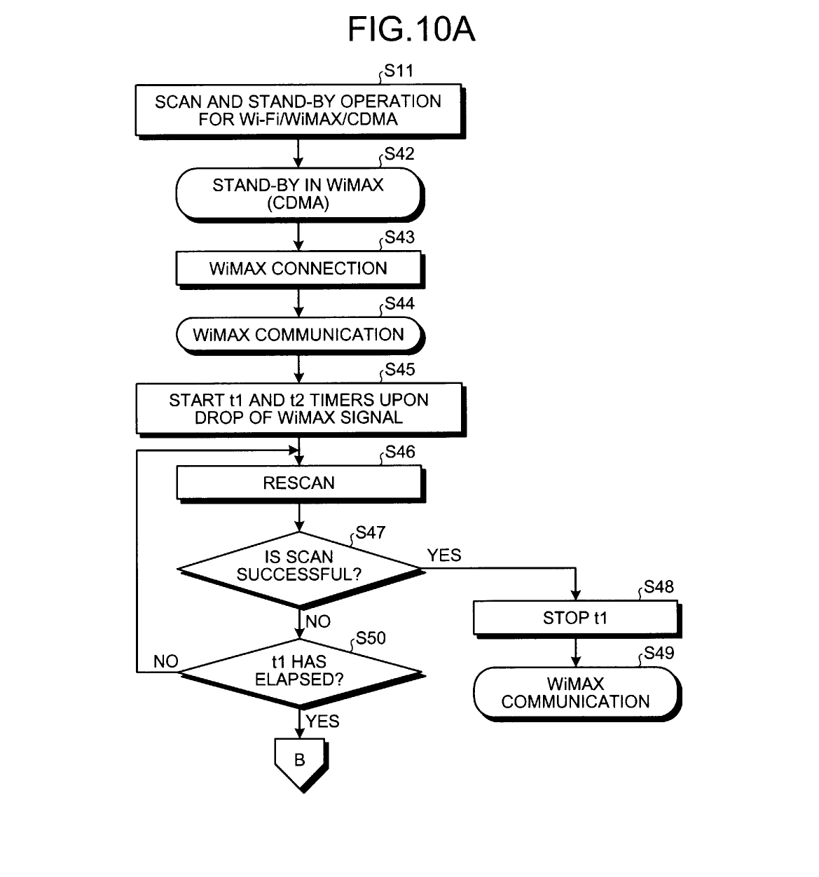

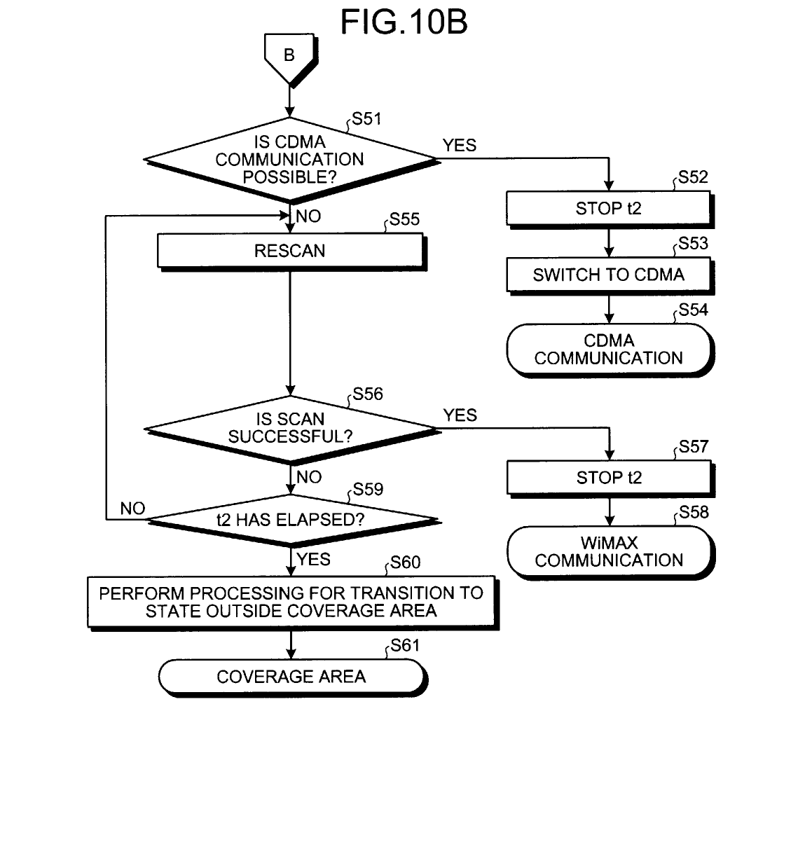

FIG. 10A is a flowchart of the wireless communication method according to the second embodiment, and FIG. 10B is the continuation thereof. As depicted in FIG. 10A, upon start of the wireless communication method, the Wi-Fi controller 72, the WiMAX controller 73, the CDMA controller 74, and the switching controller 77 of the wireless communication terminal 21 perform a scan and stand-by operation for Wi-Fi, WiMAX, and CDMA (step S11). As a result, the wireless communication terminal 21 enters stand-by mode in the WiMAX access network 25, for example (step S42).

If the result of the scan indicates that the Wi-Fi access network 22 is connectable, the wireless communication terminal 21 enters stand-by mode in the Wi-Fi access network 22. If the result of the scan indicates that neither the Wi-Fi access network 22 nor the WiMAX access network 25 is connectable but the CDMA access network 28 is connectable, the wireless communication terminal 21 enters stand-by mode in the CDMA access network 28. Here, it is assumed that the wireless communication terminal 21 enters stand-by mode in the WiMAX access network 25. In this case, the first network is the WiMAX access network 25.

The WiMAX controller 73 and the switching controller 77 connect to the WiMAX access network 25 (step S43), thereby starting WiMAX communication (step S44). If the wireless communication terminal 21 drops a signal from the WiMAX base station 27 while in the stand-by mode during the WiMAX communication, the timer manager 76 starts the t1 timer and the t2 timer (step S45). During the counting by the t1 timer, the Wi-Fi controller 72, the WiMAX controller 73, the CDMA controller 74, and the switching controller 77 perform rescanning (step S46). The rescanning for Wi-Fi and CDMA can be omitted at step S46.

If rescanning is successful (step S47: YES) and the wireless communication terminal 21 can revert to the stand-by mode in the WiMAX access network 25, the timer manager 76 stops the t1 timer (step S48) and the wireless communication terminal 21 resumes WiMAX communication by the WiMAX controller 73 (step S49). If rescanning fails (step S47: NO), until the t1 timer finishes counting (step S50: NO), the Wi-Fi controller 72, the WiMAX controller 73, the CDMA controller 74, and the switching controller 77 repeat rescanning (step S46 to step S50).

When the t1 timer finishes counting (step S50: YES), as depicted in FIG. 10B, the switching controller 77 determines whether CDMA communication is possible (step S51). If possible (step S51: YES), the timer manager 76 stops the t2 timer (step S52). The switching controller 77 switches the communication scheme to CDMA (step S53), and the wireless communication terminal 21 starts CDMA communication by the CDMA controller 74 (step S54). In this case, the second network is the CDMA access network 28.

On the other hand, if CDMA communication is not possible (step S51: NO), the Wi-Fi controller 72, the WiMAX controller 73, the CDMA controller 74, and the switching controller 77 perform rescanning (step S55). The rescanning for Wi-Fi and CDMA can be omitted at step S55.

If rescanning is successful (step S56: YES) and the wireless communication terminal 21 can revert to the stand-by mode in the WiMAX access network 25, the timer manager 76 stops the t2 timer (step S57) and the wireless communication terminal 21 resumes WiMAX communication by the WiMAX controller 73 (step S58). If rescanning fails (step S56: NO), until the t2 timer finishes counting (step S59: NO), the Wi-Fi controller 72, the WiMAX controller 73, the CDMA controller 74, and the switching controller 77 repeat rescanning (step S55 to step S59).

When the t2 timer finishes counting (step S59: YES), the switching controller 77 releases the identification information (e.g., IP address), and performs processing for transitioning to a state of being outside the coverage area (step S60). Thus, the wireless communication terminal 21 becomes outside the coverage area (step S61). The wireless communication terminal 21 that is out of the coverage area repeats step S11 and subsequent processes.

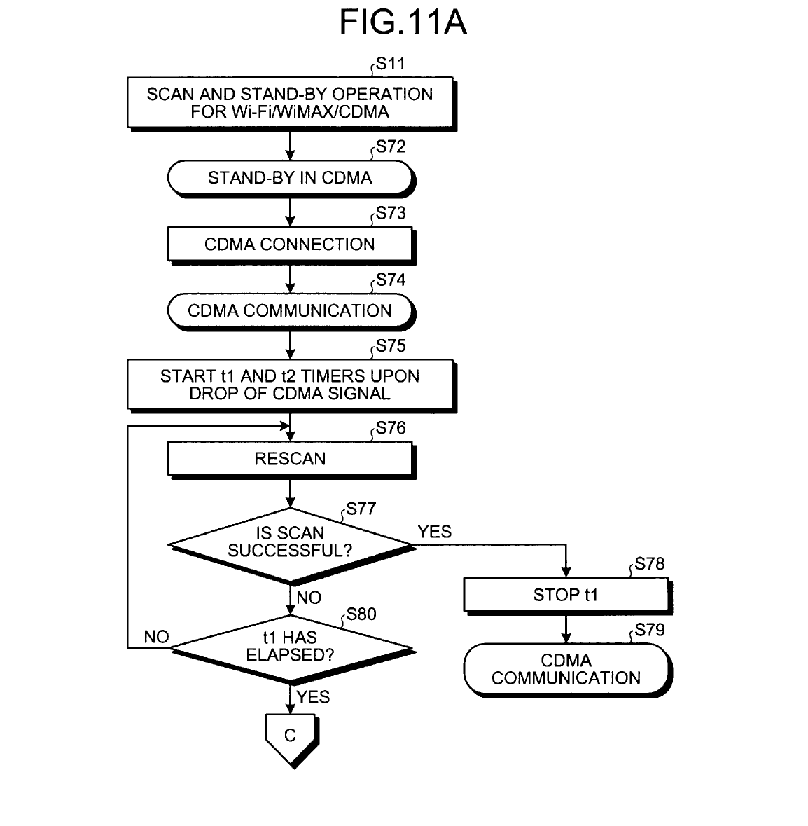

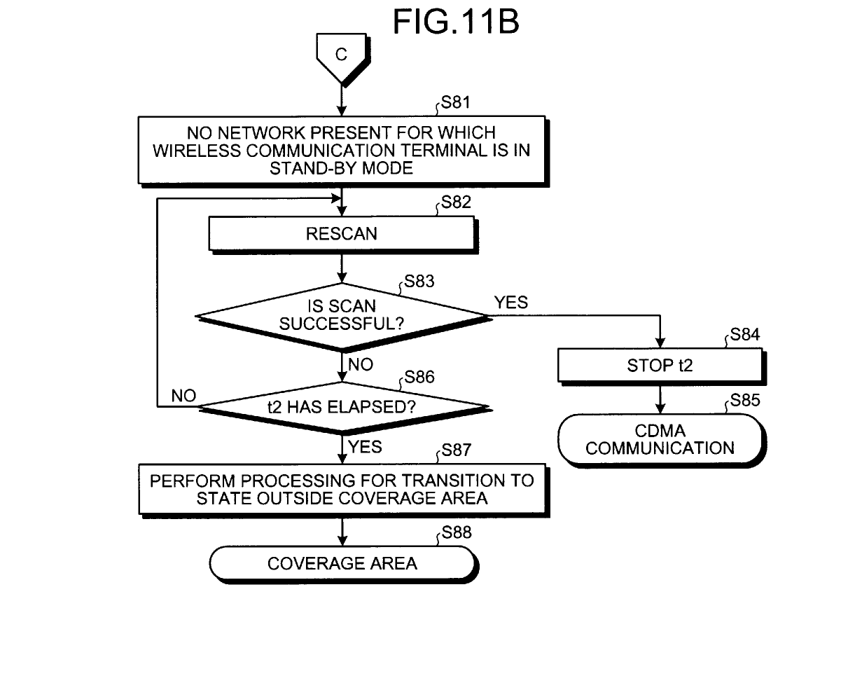

FIG. 11A is a flowchart of the wireless communication method according to the second embodiment, and FIG. 11B is the continuation thereof. As depicted in FIG. 11A, upon start of the wireless communication method, the Wi-Fi controller 72, the WiMAX controller 73, the CDMA controller 74, and the switching controller 77 of the wireless communication terminal 21 perform a scan and stand-by operation for Wi-Fi, WiMAX, and CDMA (step S11). As a result, the wireless communication terminal 21 enters stand-by mode in the CDMA access network 28, for example (step S72).

If the result of the scan indicates that the Wi-Fi access network 22 is connectable, the wireless communication terminal 21 enters stand-by mode in the Wi-Fi access network 22. If the result of the scan indicates that the Wi-Fi access network 22 is not connectable but the WiMAX access network 25 is connectable, the wireless communication terminal 21 enters stand-by mode in the WiMAX access network 25. Here, it is assumed that the wireless communication terminal 21 enters stand-by mode in the CDMA access network 28. In this case, the first network is the CDMA access network 28.

The CDMA controller 74 and the switching controller 77 connect to the CDMA access network 28 (step S73), thereby starting CDMA communication (step S74). If the wireless communication terminal 21 drops a signal from the CDMA base station 30 while in the stand-by mode during the CDMA communication, the timer manager 76 starts the t1 timer and the t2 timer (step S75). During the counting by the t1 timer, the Wi-Fi controller 72, the WiMAX controller 73, the CDMA controller 74, and the switching controller 77 perform rescanning (step S76). The rescanning for Wi-Fi and WiMAX can be omitted at step S76.

If rescanning is successful (step S77: YES) and the wireless communication terminal 21 can revert to the stand-by mode in the CDMA access network 28, the timer manager 76 stops the t1 timer (step S78), and the wireless communication terminal 21 resumes CDMA communication by the CDMA controller 74 (step S79). If rescanning fails (step S77: NO), until the t1 timer finishes counting (step S80: NO), the Wi-Fi controller 72, the WiMAX controller 73, the CDMA controller 74, and the switching controller 77 repeat rescanning (step S76 to step S80).

When the t1 timer finishes counting (step S80: YES), as depicted in FIG. 11B, there is no communication network for which the wireless communication terminal 21 is in the stand-by mode (step S81). In other words, there is no connectable second network. Thus, the Wi-Fi controller 72, the WiMAX controller 73, the CDMA controller 74, and the switching controller 77 perform rescanning (step S82). The rescanning for Wi-Fi and WiMAX can be omitted at step S82.

If rescanning is successful (step S83: YES) and the wireless communication terminal 21 can revert to the stand-by mode in the CDMA access network 28, the timer manager 76 stops the t2 timer (step S84) and the wireless communication terminal 21 resumes CDMA communication by the CDMA controller 74 (step S85). If rescanning fails (step S83: NO), until the t2 timer finishes counting (step S86: NO), the Wi-Fi controller 72, the WiMAX controller 73, the CDMA controller 74, and the switching controller 77 repeat rescanning (step S82 to step S86).

When the t2 timer finishes counting (step S86: YES), the switching controller 77 releases the identification information (e.g., IP address), and performs processing for transitioning to a state of being outside the coverage area (step S87). Thus, the wireless communication terminal 21 becomes outside the coverage area (step S88). The wireless communication terminal 21 that is out of the coverage area repeats step S11 and subsequent processes.

In the flowcharts described above, if the wireless communication terminal 21 becomes outside the coverage area at step S35, S61, or S88 and then enters stand-by mode in the Wi-Fi access network 22 as a result of the scan and the stand-by operation at step S11, the process proceeds to step S12. If the wireless communication terminal 21 enters stand-by mode in the WiMAX access network 25, the process proceeds to step S42. If the wireless communication terminal 21 enters stand-by mode in the CDMA access network 28, the process proceeds to step S72.

If the wireless communication terminal 21 resumes Wi-Fi communication at step S19 or S32, the process proceeds to step S14. If WiMAX communication is started at step S24, S49, or S58, the process proceeds to step S44. If CDMA communication is started at step S28, S54, S79, or S85, the process proceeds to step S74.

According to the second embodiment, effects similar to those of the first embodiment can be obtained.

The t2 timer need not be started at the same time as the t1 timer provided the t2 timer finishes counting at a timing later than the timing at which the t1 timer finishes counting. The wireless communication terminal is not limited to a mobile phone, and may be a mobile data terminal, a mobile game terminal, or a various types of measuring instruments that are compatible with multiple communication schemes. The wireless communication terminal may be a so-called “smart phone” that is a terminal functioning as both the mobile phone and the mobile data terminal. In the first and the second embodiments, the timer may be implemented by software or hardware. The number of timers may be one or more than one.

The wireless communication terminal and the wireless communication method can achieve a stabilized communication environment and a shorter time during which an application cannot transmit/receive data.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication terminal comprising:
a wireless communication circuit that connects to any one of a first network by wireless communication according to a communication protocol corresponding to the first network and a second network by wireless communication according to a communication protocol corresponding to the second network;
a processor that controls switching of a network to which the wireless communication circuit connects; and
a timer that
starts to count based on a state of wireless communication and finishes counting a first time period after a given time period has elapsed, and
starts to count based on the state of wireless communication and finishes counting a second time period that is longer than the first time period, wherein
the processor
maintains the first network to which the wireless communication circuit connects and attempts to re-connect to the first network until the timer finishes counting the first time period,
switches a destination of the wireless communication circuit to the second network if there is a connectable second network when the timer finishes counting the first time period, and
attempts, until the timer finishes counting the second time period, to re-connect to the first network that has been maintained as the destination until the timer finishes counting the first time period, if there is no connectable second network when the timer finishes counting the first time period.

2. The wireless communication terminal according to claim 1, wherein the timer includes:
a first timer that starts to count based on the state of wireless communication and finishes counting the first time period after a given time period has elapsed; and
a second timer that starts to count based on the state of wireless communication and finishes counting the second time period that is longer than the first time period.

3. The wireless communication terminal according to claim 1, therein the timer starts to count when the state of wireless communication deteriorates.

4. The wireless communication terminal according to claim 2, wherein the first timer and the second timer start to count when the state of wireless communication deteriorates.

5. The wireless communication terminal according to claim 1, wherein a time period from the start to the end of the counting based on the first time period and the second time period is determined for each network.

6. The wireless communication terminal according to claim 1, wherein the processor releases, when the timer finishes counting the second time period, identification information assigned by the first network such that the wireless communication terminal becomes outside a coverage area.

7. The wireless communication terminal according to claim 1, wherein the communication schemes include wireless fidelity (Wi-Fi), world interoperability for microwave access (WiMAX), and code division multiple access (CDMA) 1x/evolution data only (EVDO).

8. The wireless communication terminal according to claim 7, wherein the time from the start to the end of the counting based on the first time period and the time from the start to the end of the counting based on the second time period are long in the order of CDMA 1x/EVDO, WiMAX, and Wi-Fi.

9. A wireless communication method comprising:
maintaining a destination first network and attempting to re-connect to the first network according to a communication scheme corresponding to the first network until a first time period elapses, wherein the first time period starts based on a state of wireless communication and ends when a given time period elapses;
switching a destination to a second network if there is the second network that is connectable according to another communication scheme, when the first time period has elapsed; and
starting to count based on a state of wireless communication, and until a second time period that is longer than the first time period elapses, attempting to re-connect to the first network that has been maintained as the destination until the first time period elapses, if there is no second network that is connectable according to the other communication scheme when the first time period has elapsed.

10. The wireless communication method according to claim 9, wherein the first time period and the second time period start when the state of wireless communication deteriorates.

11. The wireless communication method according to claim 9, wherein the first time period and the second time period are determined for each network.

12. The wireless communication method according to claim 9, further comprising releasing, when the second time period elapses, identification information assigned by the first network such that a wireless communication terminal becomes outside a coverage area.

13. The wireless communication method according to claim 9, wherein the communication schemes include wireless fidelity (Wi-Fi), world interoperability for microwave access (WiMAX), and code division multiple access (CDMA) 1x/evolution data only (EVDO).

14. The wireless communication method according to claim 13, wherein the first time period and the second time period are long in the order of CDMA 1x/EVDO, WiMAX, and Wi-Fi.
